(19) United States
(12) Patent Application Publication
(10) Pub. No.: US 2021/0264099 A1
(43) Pub. Date: Aug. 26, 2021

(54) INFORMATION PROCESSING DEVICE AND COMPUTER READABLE MEDIUM

(71) Applicant: FUJIFILM BUSINESS INNOVATION CORP., Tokyo (JP)

(72) Inventor: Takanori ONO, Yokohama-shi (JP)

(73) Assignee: FUJIFILM BUSINESS INNOVATION CORP., Tokyo (JP)

(21) Appl. No.: 16/983,049

(22) Filed: Aug. 3, 2020

(30) Foreign Application Priority Data
Feb. 26, 2020 (JP) 2020-030618
Feb. 26, 2020 (JP) 2020-030624

(51) Int. Cl. G06F 40/174; G06F 40/106; G06K 9/00

(52) U.S. Cl. CPC G06F 40/174; G06F 40/106; G06K 2209/01; G06K 9/00469; G06K 9/00463

(57) ABSTRACT

An information processing device includes: a processor configured to associate, for a document of plural documents, common definition data that defines content of a common item commonly used in the plural documents including the document, among at least one item read from the document, and individual definition data that defines content of an item individually for each of the plural documents, among the at least one item read from the document, with document data representing the document.

### CROSS-REFERENCE TO RELATED APPLICATIONS

This application is based on and claims priority under 35 USC 119 from Japanese Patent Application No. 2020-30618 filed on Feb. 26, 2020 and Japanese Patent Application No. 2020-30624 filed on Feb. 26, 2020.

### BACKGROUND

### Technical Field

The present invention relates to an information processing device and a non-transitory computer readable medium.

### Related Art

A technology of reading a document and performing character recognition is known.

JP-A-H10-207981 describes a device that defines an item name of a form and logical layout information of an entry frame, by comparing a relative positional relationship of a frame region extracted from an image of the form with the physical layout information, identifies the frame region corresponding to the item name of the form image and the entry frame, and performs character recognition of at least the frame region identified as the entry frame.

JP-A-H6-119491 describes a device that extracts quadrangles circumscribing a series of white pixels from image data of an input form, determines a quadrangle having a size equal to or larger than a threshold as an entry frame, collates a physical layout of an item obtained from the determined entry frame and definition information, and determines a type of the entry frame.

### SUMMARY

Content of the item read from a document or the like may be predefined by a user, and the document may be read according to the definition. In this case, the content of the item to be read may be separately defined for each individual document for plural types of documents. However, according to such a definition method, a common definition among the plural types of documents needs to be redefined for each document, and as the number of types of documents increases, a burden on the user increases.

Aspects of non-limiting embodiments of the present disclosure relate to reducing a burden of an operation when a user defines content of a common item among items to be read from plural types of documents, compared to defining each individual document separately.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including: a processor configured to associate, for a document of plural documents, common definition data that defines content of a common item commonly used in the plural documents including the document, among at least one item read from the document, and individual definition data that defines content of an item individually for each of the plural documents, among the at least one item read from the document, with document data representing the document.

### BRIEF DESCRIPTION OF DRAWINGS

Exemplary embodiment(s) of the present invention will be described in detail based on the following figures, wherein:

FIG. 1 is a block diagram showing a hardware configuration of an information processing device according to a first exemplary embodiment;

FIG. 2 is a functional block diagram showing a functional configuration of the information processing device according to the first exemplary embodiment;

FIG. 3 is a flowchart showing processing according to the first exemplary embodiment;

FIG. 4 is a diagram showing a structure of document definition data according to the first exemplary embodiment;

FIG. 5 is a diagram showing forms, common definition data and individual definition data;

FIG. 6 is a diagram showing definition data according to a comparative example;

FIG. 7 is a diagram showing a screen according to an example;

FIG. 8 is a diagram showing a screen according to an example;

FIG. 9 is a diagram showing forms and common definition data according to an example;

FIG. 10 is a block diagram showing a functional configuration of an information processing device according to a second exemplary embodiment;

FIG. 11 is a flowchart showing processing according to the second exemplary embodiment;

FIG. 12 is a diagram showing a structure of document definition data according to the second exemplary embodiment;

FIG. 13 is a diagram showing a document to be associated and an individual definition setting screen according to an example;

FIG. 14 is a diagram showing a common definition setting screen according to an example;

FIG. 15 is a diagram showing an editing screen according to an example; and

FIG. 16 is a view showing a screen according to an example.

### DETAILED DESCRIPTION

### First Exemplary Embodiment

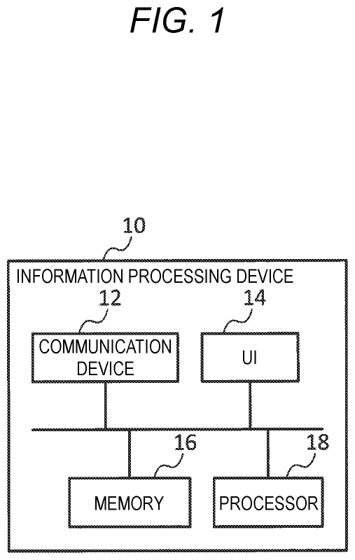

A hardware configuration of an information processing device according to a first exemplary embodiment will be described with reference to FIG. 1. FIG. 1 shows an example of a hardware configuration of an information processing device 10 according to the first exemplary embodiment.

The information processing device 10 is a device used to create document definition data serving as data that defines content of an item read from a document and the like, and is, for example, a desktop or notebook personal computer, a workstation, a tablet terminal, a smartphone, a scanner, a multifunction peripheral (for example, a device including a scanner and a printer), or a digital camera. For example, the document definition data is used to read the document and perform character recognition (for example, optical character recognition (OCR)).

Here, the document definition data will be described. The document definition data is the data in which document data serving as data representing the document, common definition data and individual definition data are associated. More specifically, a frame is extracted from the document data, and frame data serving as data representing the frame, the common definition data and the individual definition data are associated to create the document definition data. The frame is a region surrounded by a line, a symbol (for example, the symbol such as a parenthesis) or the like, and is, for example, a region where characters and the like are assumed to be entered (for example, an entry field described in a form or the like), a region where characters and the like are not assumed to be entered, and the like. The information processing device 10 performs the association.

A type and a format of the document data are not particularly limited. A concept of the document data includes, for example, image data representing the document, text data, document data created by word processor software, spreadsheet data created by spreadsheet software and data displayed by a web browser.

The common definition data is data that defines content of a common item among items to be read in plural documents. The item to be read in the document is an item serving as a target of character recognition processing such as OCR processing, that is, an item in which characters and symbols are read by the character recognition processing. For example, the item to be read corresponds to the frame in the document. Specifically, the common definition data is the data that defines a name of the item to be read, a type of a dictionary of the item to be read (for example, the type of the dictionary used for the character recognition processing such as alphanumeric characters, numbers, company names and other general dictionaries), a format of the item to be read (for example, the format of a character or a numerical value), and the like. These are merely examples, and other than these, common content among the plural documents may be defined by the common definition data.

The individual definition data is data that defines content of an item individually for each document among items to be read in the document. For example, the individual definition data is the data that defines a layout of the item in the document. Specifically, the individual definition data is the data that defines a layout of the frame extracted from the document (for example, a position in the document), a type of the frame, a type of a dictionary used for the character recognition processing (for example, a dictionary to be applied to handwriting or a dictionary to be applied to typing), and the like. In addition, setting of a read mask, a certainty degree threshold and the like may be defined by the individual definition data. As described above, an item extracted from the document corresponds to the item to be read, and the layout of the frame corresponds to the layout of the item corresponding to the frame (for example, the position in the document). The position of the frame may be defined by absolute coordinates in the document or may be a relative position between frames. The type of the dictionary defined by the individual definition data is a type of the dictionary not defined by the common definition data. These are merely examples, and other than these, content of the item that should be individually defined for each document may be defined by the individual definition data. For example, the content of the item that is not common among the plural documents may be defined by the individual definition data for each individual document.

As described above, the common definition data and the individual definition data are used as definition data. For example, the name of the item common among the plural documents is defined by the common definition data, and the layout of the item is defined by the individual definition data for each individual document. For example, the name of the item to be read is common among the plural documents, but the layout of the item may be different for each document. For example, when a column in which a name is entered is described in both documents A, B, the column corresponds to the item common in the documents A, B, and the name corresponds to the name of the item common in the documents A, B. On the other hand, an layout of the column may be different between the documents A, B as described in an upper part of the document A and a lower part of the document B. In this way, the name of the item to be read is common in the documents A, B, but the layout of the item may be different between the documents A, B. In this case, the name of the item is defined by the common definition data common in the documents A, B, the layout of the item in the document A is defined by the individual definition data of the document A, and the layout of the item in the document B is defined by the individual definition data of the document B. That is, the layout of the item is defined by separate individual definition data.

In the document definition data, plural different pieces of common definition data and plural different pieces of individual definition data may be associated with the frame data.

As shown in FIG. 1, the information processing device 10 includes, for example, a communication device 12, a UI 14, a memory 16 and a processor 18. The information processing device 10 may include other configurations. For example, when the information processing device 10 is the multifunction peripheral, the information processing device 10 may include the scanner and the printer.

The communication device 12 is a communication interface (for example, a network interface) having a communication chip or the like, and has a function of transmitting data to another device and a function of receiving data transmitted from another device.

The UI 14 is a user interface and includes at least one of a display device and an operation device. The display device is a liquid crystal display, an EL display or the like. The operation device is a keyboard, input keys, an operation panel or the like. The UI 14 may be a UI such as a touch panel having both the display device and the operation device. The memory 16 is a device constituting one or plural storage regions for storing data.

The memory 16 is, for example, a hard disk drive, various memories (for example, RAM, DRAM and ROM), other storage devices (for example, optical disks), or a combination thereof.

The processor 18 is configured to control an operation of each unit of the information processing device 10. The processor 18 may include a memory. The processor 18 is configured to associate the common definition data and the individual definition data with the frame data for each document.

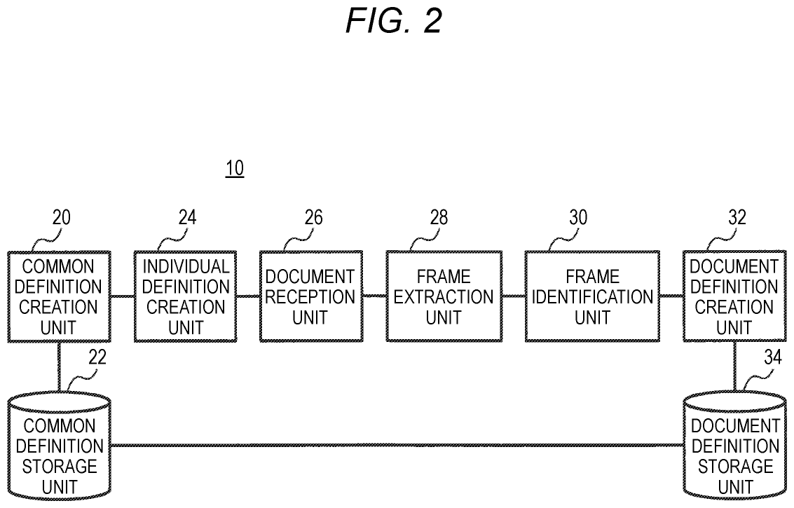

A functional configuration of the information processing device 10 according to the first exemplary embodiment will be described below with reference to FIG. 2. FIG. 2 shows an example of the functional configuration of the information processing device 10.

A common definition creation unit 20 is configured to create the common definition data common in the plural documents. For example, when the name of the item, the type of the dictionary, the format and the like to be defined by the common definition data are designated by an operator, the common definition creation unit 20 creates the common definition data that defines them. The common definition creation unit 20 may edit, delete or select the created common definition data. The common definition creation unit 20 may create the plural different pieces of common definition data.

A common definition storage unit 22 is configured to store the common definition data created by the common definition creation unit 20. For example, the common definition data is stored in the common definition storage unit 22 in association with common definition identification information serving as information for identifying the common definition data.

An individual definition creation unit 24 is configured to create the individual definition data for each document. For example, when the layout of the frame (that is, the layout of the item corresponding to the frame), the type of the frame, the type of the dictionary and the like to be defined by the individual definition data are designated by the operator, the individual definition creation unit 24 creates the individual definition data that defines them. For example, the individual definition identification information serving as information for identifying the individual definition data is associated with the individual definition data. The individual definition creation unit 24 may create the plural different pieces of individual definition data.

A document reception unit 26 is configured to receive the document data. For example, when a document is read by the scanner or the like, image data representing the document is created, and the document reception unit 26 receives the image data. Of course, the document reception unit 26 may receive the document data having a format other than the image data.

A frame extraction unit 28 is configured to extract a frame included in the document represented by the document data from the document data received by the document reception unit 26, and to create the frame data serving as the data representing the frame. For example, a known technology is used as a technology for extracting the frame.

A frame identification unit 30 is configured to identify the frame for each document to be associated with the document definition data. Identification of the frame is to specifies the frame corresponding to the item defined by the common definition data and having the layout defined by the individual definition data. For example, the frame identification unit 30 identifies the individual definition data that defines a layout corresponding to the layout of the frame extracted from the document data to be associated (for example, a layout that matches the layout of the extracted frame) from the plural different pieces of individual definition data, and specifies the common definition data that defines an item corresponding to the item included in the document represented by the document data to be associated (for example, an item that matches the item included in the document) from the plural different pieces of common definition data. The identification of the frame may be performed by the operator.

A document definition creation unit 32 is configured to create the document definition data by associating the frame data of the document data to be associated with the common definition data and the individual definition data specified by the frame identification unit 30.

A document definition storage unit 34 is configured to store the document definition data created by the document definition creation unit 32. For example, document definition identification information serving as information for identifying the document definition data is associated with document definition data.

The common definition data itself included in the document definition data may be stored in the common definition storage unit 22, and information (for example, the common definition identification information) for referring to the common definition data may be included in the document definition data and stored in the document definition storage unit 34. That is, the frame data, the common definition identification information and the individual definition data may be associated and stored in the document definition storage unit 34. In this case, by referring to the common definition identification information, the common definition data associated with a combination of the frame data and the individual definition data may be specified, and the common definition data may be acquired from the common definition storage unit 22.

The common definition creation unit 20, the individual definition creation unit 24, the document reception unit 26, the frame extraction unit 28, the frame identification unit 30 and the document definition creation unit 32 are implemented by the processor 18. In this implementation, the memory 16 may be used. The common definition storage unit 22 and the document definition storage unit 34 are implemented by the memory 16.

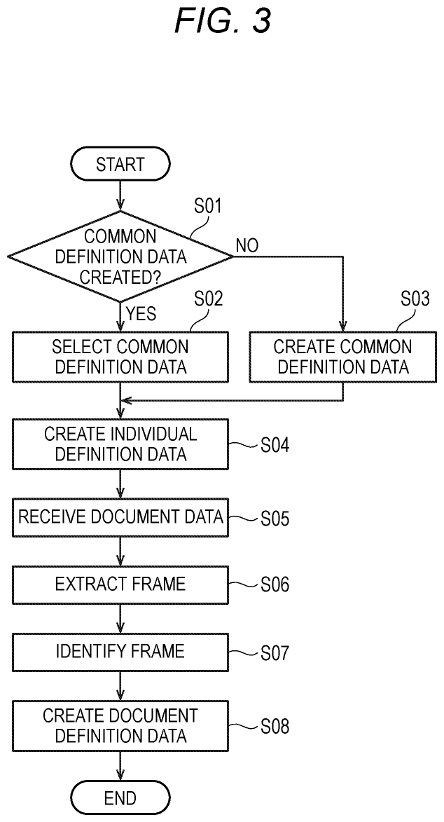

Processing by the information processing device 10 according to the first embodiment will be described below with reference to FIG. 3. FIG. 3 is a flowchart showing the processing.

First, it is determined whether the common definition data has been created (S01). This determination is performed by the processor 18.

When the common definition data has been created (S01, Yes), the common definition data is selected (S02). For example, one or more pieces of common definition data is displayed on the display device of the UI 14, and the operator may select one or more pieces of common definition data, or the processor 18 may select one or more pieces of common definition data. The created common definition data is stored in the common definition storage unit 22.

When the common definition data has not been created (S01, No), the common definition data is created (S03). For example, the common definition creation unit 20 creates one or more pieces of common definition data that defines content designated by the operator. The created common definition data is stored in the common definition storage unit 22.

The individual definition creation unit 24 creates the individual definition data (S04). For example, the individual definition creation unit 24 creates one or more pieces of individual definition data that defines content designated by the operator.

Next, the document reception unit 26 receives the document data to be associated (S05).

Next, the frame extraction unit 28 extracts the frame from the document data to be associated, thereby creating the frame data serving as the data representing the frame (S06).

Next, the frame identification unit 30 identifies the frame, thereby specifying the common definition data and the individual definition data associated with the frame data of the document data to be associated based on the common definition data, the individual definition data and the frame data (S07).

Next, the document definition creation unit 32 creates the document definition data by associating the frame data extracted from the document data to be associated with the common definition data and the individual definition data specified by the frame identification unit 30 (S08). The document definition data is stored in the document definition storage unit 34.

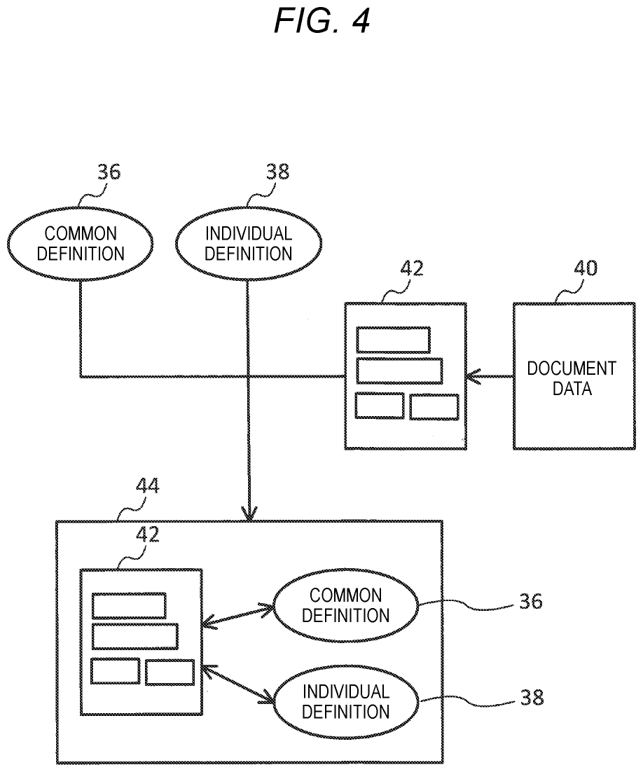

Here, a structure of the document definition data will be described with reference to FIG. 4. FIG. 4 shows an example of the structure thereof.

Here, the common definition data 36 and the individual definition data 38 have been created. When document data 40 to be associated is received and a frame is extracted from the document data 40, frame data 42 serving as data representing the frame is created. By identifying the frame, common definition data 36 and individual definition data 38 associated with the frame data 42 are identified. Then, the frame data 42, the common definition data 36 and the individual definition data 38 are associated to create document definition data 44.

A specific example of the common definition data will be described below. Here, the specific example will be described by taking a form serving as an example of the document as an example.

For example, in a case where the form is an invoice, one or more items shown below are items to be read from the form and may be defined as the common definition data:

1. invoice number: alphanumeric, dictionary [alphanumeric], 10 digits

2. product name: character string, dictionary [general]

3. amount: numerical value (amount), dictionary [number]

4. supplier name: character string, dictionary [company name]

5. quantity: numerical value, dictionary [number]

6. payment due date: date, dictionary [date].

[1. invoice number], [2. product name], [3. amount], [4. supplier name], [5. quantity] and [6. payment due date] are examples of names of the items to be read. In this form, an entry field of each of [1. invoice number], [2. product name], [3. amount], [4. supplier name], [5. quantity] and [6. payment due date] is described, and characters, symbols or the like are assumed to be entered in each entry field. The entry field of each item is constituted by a frame. That is, inside of the frame corresponds to the entry field. A layout of the frame is defined by the individual definition data. A type of the dictionary of each item is an example of the type of the dictionary used in the character recognition processing. For example, the dictionary [alphanumeric] is a dictionary specialized in alphanumeric characters. The character string or the numerical value is an example of the format of the content to be read. Also, the number of characters and the number of digits are defined.

For example, the entry field of the item [1. invoice number] in the form is an entry field where 10 digits of alphanumeric characters are assumed to be entered. Since the alphanumeric characters are assumed to be entered, the dictionary specialized in alphanumeric characters is defined in the item [1. invoice number]. The entry field of the item [2. product name] is an entry field where the character string is assumed to be entered. Since the character string is assumed to be entered, a general dictionary is defined in the item [2. product name]. The same applies to the other items. For example, the name of each item, the dictionary and the format used, and the like are defined by the operator, and the common definition creation unit 20 creates the common definition data representing the definition.

A specific example of the individual definition data will be described below.

For example, the entry field of [1. invoice number] is described in the first line of the form, the entry field of each of [4. supplier name], [2. product name], [5. quantity] and [3. amount] is described in that order in the second line, and the entry field of [6. payment due date] is described in the third line. In this case, a layout of each item in the form is defined as follows. 1{typing, ladder frame} 4{typing, text frame} &2{handwriting, text frame} &5 {handwriting, text frame} &3 {handwriting, ladder frame} 6{typing, text frame}

For example, the entry field of the item [1. invoice number] in the form is an entry field described in the first line, and the entry field where the alphanumeric characters are assumed to be described by handwriting. The “ladder frame” is an example of the format of the frame. For example, by connecting plural frames, one frame is formed as a whole and is defined as the “ladder frame”. The entry field of the item [1. invoice number] is the entry field constituted by the ladder frame, and is the entry field where the alphanumeric characters are assumed to be described by handwriting. The “text frame” is an example of the format of the frame, and is, for example, a frame constituted by only one frame. For example, the format of typing or handwriting, the format of the frame, or the like is defined by the operator, and the individual definition creation unit 24 creates the individual definition data representing the definition.

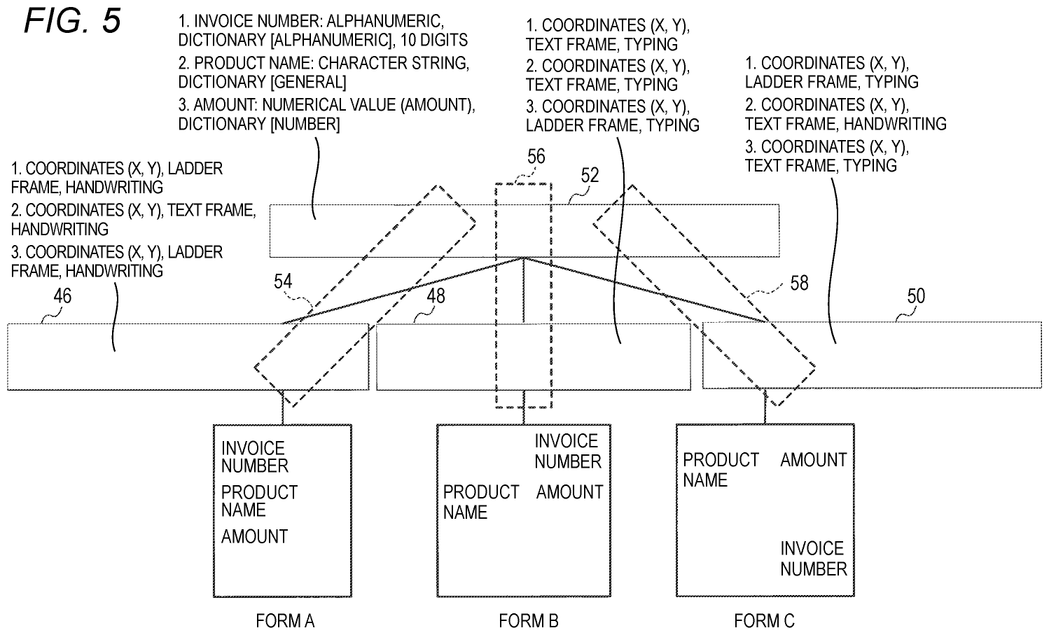

Hereinafter, the common definition data and the individual definition data will be described in detail with reference to a specific example of the form. FIG. 5 shows the example of forms, the common definition data and the individual definition data. FIG. 5 shows forms A, B, C as the example. In the forms A, B, C, the entry field of each of the item [1. invoice number], the item [2. product name] and the item [3. amount] is formed.

Individual definition data 46 is the individual definition data of the form A, individual definition data 48 is the individual definition data of the form B, and individual definition data 50 is the individual definition data of the form C. Individual definition data 46, 48, 50 is different individual definition data.

In each individual definition data, the layout (for example, coordinates in the form), the format of the frame and the format of the characters are defined for each of the entry field of the item [1. invoice number], the entry field of the item [2. product name] and the entry field of the item [3. amount].

For example, the individual definition data 46 defines that the layout of the entry field of the item [1. invoice number] in the form A (for example, coordinates in the form A), the format of the frame of the entry field are the “ladder frame”, and that the format of the characters is the “handwriting”. The same applies to other items. The same applies to the individual definition data 48, 50.

Common definition data 52 is data that defines common content among the items to be read in the forms A, B, C. In the forms A, B, C, the entry field of each of the item [1. invoice number], the item [2. product name] and the item [3. amount] is described, and the name of each item, the dictionary used for each item, the format and the like are common in the forms A, B, C. For example, in the forms A, B, C, 10 digits of alphanumeric characters are assumed to be entered in the entry field of the item [1. invoice number], and the dictionary specialized in alphanumeric characters is assumed to be used in the character recognition processing. Since these content are common in the forms A, B, C, these content are defined by the common definition data 52 of the forms A, B, C. The same applies to the item [2. product name] and the item [3. amount].

Form definition data 54 is the document definition data of the form A. That is, the form definition data 54 is definition data in which the frame data serving as data representing the frame extracted from the form A, the individual definition data 46 and the common definition data 52 are associated.

Form definition data 56 is the document definition data of the form B. That is, the form definition data 56 is definition data in which the frame data serving as data representing the frame extracted from the form B, the individual definition data 48 and the common definition data 52 are associated.

The form definition data 58 is the document definition data of the form C. That is, the form definition data 58 is definition data in which the frame data serving as data representing the frame extracted from the form C, the individual definition data 50 and the common definition data 52 are associated.

For example, the frame identification unit 30 identifies the individual definition data 46 that defines a layout that matches the layout of each frame extracted from the form A from the individual definition data 46, 48, 50. The frame identification unit 30 specifies the common definition data 52 that defines an item that matches the item in the form A from the plural different pieces of common definition data. For example, by executing the character recognition processing on the document data representing the form A, the frame identification unit 30 extracts the character string indicating the name of each item in the form A, and specifies the common definition data 52 that defines the item of the extracted name. Then, the document definition creation unit 32 associates the individual definition data 46 and the common definition data 52 with the frame data serving as the data representing each frame extracted from the form A. Of course, the operator may associate the individual definition data 46 and the common definition data 52 with the frame data of the form A. The same applies to the forms B, C.

The frame data of the form A, the common definition identification information serving as information for identifying the common definition data 52, and the individual definition data 46 are associated and stored in the document definition storage unit 34. Similarly, the frame data of the form B, the common definition identification information for the common definition data 52, and the individual definition data 48 are associated and stored in the document definition storage unit 34. Similarly, the frame data of the form C, the common definition identification information for the common definition data 52, and the individual definition data 48 are associated and stored in the document definition storage unit 34. The common definition data 52 is stored in the common definition storage unit 22.

For example, when the characters or symbols are written in the form A by a writer and the character recognition processing such as the OCR processing is performed on the written form A, the form definition data 54 is used in the character recognition processing. Specifically, the character recognition processing is performed on the written form A by using the common definition data 52 serving as the common definition data stored in the common definition storage unit 22 and identified by the common definition identification information associated with the frame data of the form A, and the individual definition data 46 serving as the individual definition data stored in the document definition storage unit 34 and associated with the frame data of the form A. For example, regarding the written form A, a position of the entry field of the item [1. invoice number], the format of the frame, the format of the characters, and the like are specified by definition content of the individual definition data 46, and the character recognition processing using the dictionary specialized in alphanumeric characters is performed on the entry field of the item [1. invoice number] according to definition content of the common definition data 52. The same applies to the forms B, C.

As described above, the common definition data 52 is shared by the form definition data of each form. For example, when the common definition data 52 is edited by the common definition creation unit 20, the document definition creation unit 32 reflects the editing on each form (for example, the forms A, B, C) associated with the common definition data 52. Specifically, the document definition creation unit 32 reflects the editing on form definition data 54, 56, 58 including the common definition identification information of the common definition data 52. That is, since the form definition data 54, 56, 58 are associated with the common definition identification information of one common definition data 52, when the common definition data 52 is edited, the editing of the common definition data 52 is reflected on the form definition data 54, 56, 58 even if the form definition data 54, 56, 58 is not individually edited.

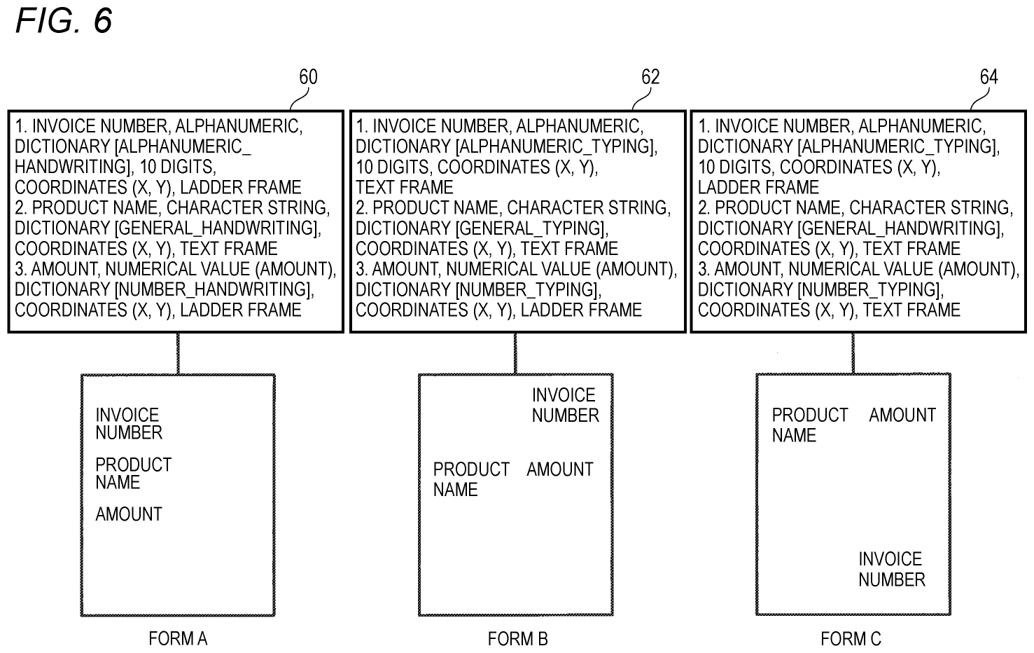

Here, a comparative example will be described with reference to FIG. 6. FIG. 6 shows definition data according to the comparative example. Definition data 60 is the definition data of the form A according to the comparative example, definition data 62 is the definition data of the form B according to the comparative example, and definition data 64 is the definition data of the form C according to the comparative example. The forms A, B, C shown in FIG. 6 are forms the same as the forms A, B, C shown in FIG. 5. In the comparative example, the common definition data and the individual definition data are not distinguished, and the definition data including all definition content is created for each form.

In the comparative example, when the definition data is edited, the definition data needs to be edited for each form even when common content in the forms A, B, C is changed. On the other hand, in the present exemplary embodiment, when the common definition data 52 is edited, the editing is reflected in the form definition data of each of the forms A, B, C.

A modification of the first exemplary embodiment will be described below.

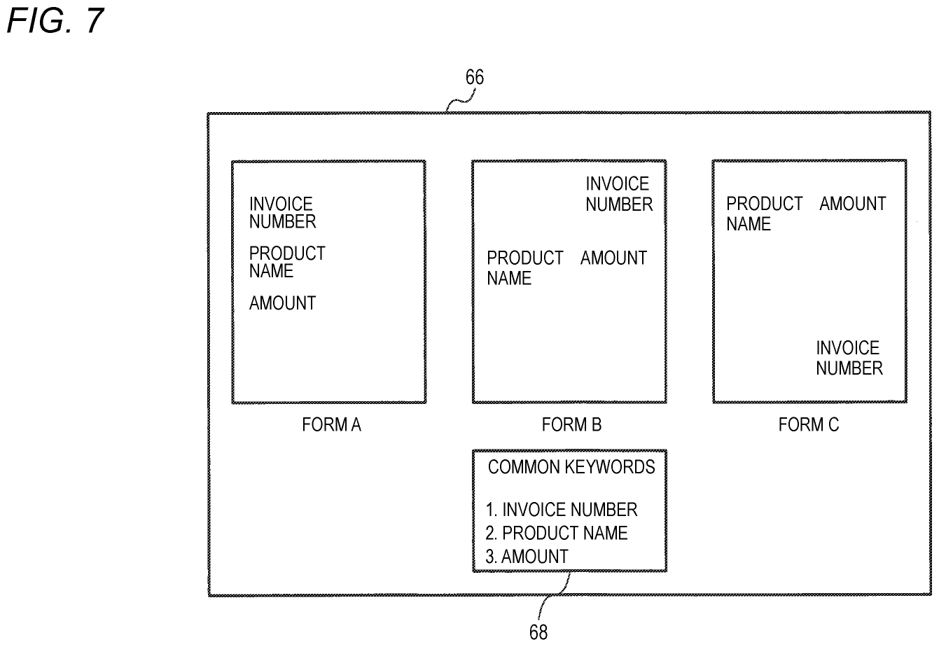

The processor 18 may display the common item to be read in the plural documents to the user (for example, the operator). This point will be described in detail with reference to FIG. 7. FIG. 7 shows an example of a screen displayed on the display device.

As the example, the forms A, B, C are documents to be associated, and document data of each of the forms A, B, and C is received by the document reception unit 26. The processor 18 displays images of the forms A, B, C side by side on a screen 66. The screen 66 may be displayed on the display device of the UI 14, or may be displayed on a terminal device (for example, a personal computer) used by the operator.

In the forms A, B, C, the entry field (for example, the entry field constituted by the frame) of each of the item [invoice number], the item [product name] and the item [amount] is described, and a character string “invoice number”, a character string “product name” and a character string “amount” are described. The processor 18 executes the character recognition processing on the document data of each of the forms A, B, C to extract these character strings. These character strings are common character strings extracted from the each of the forms A, B and C. In this case, the processor 18 displays these character strings on the screen 66 as common keywords in the forms A, B, C, as indicated by reference numeral 68. The processor 18 may display, on the screen 66, a message that proposes to the operator that the common items in the forms A, B, C (for example, the item [invoice number], the item [product name] and the item [amount]) are included in the common definition data.

When the operator selects a specific keyword from the common keywords using the UI 14 or the like, the processor 18 may include the item corresponding to the selected keyword in the common definition data. For example, when the item [1. invoice number] is selected by the operator, the processor 18 includes the item [1. invoice number] in the common definition data.

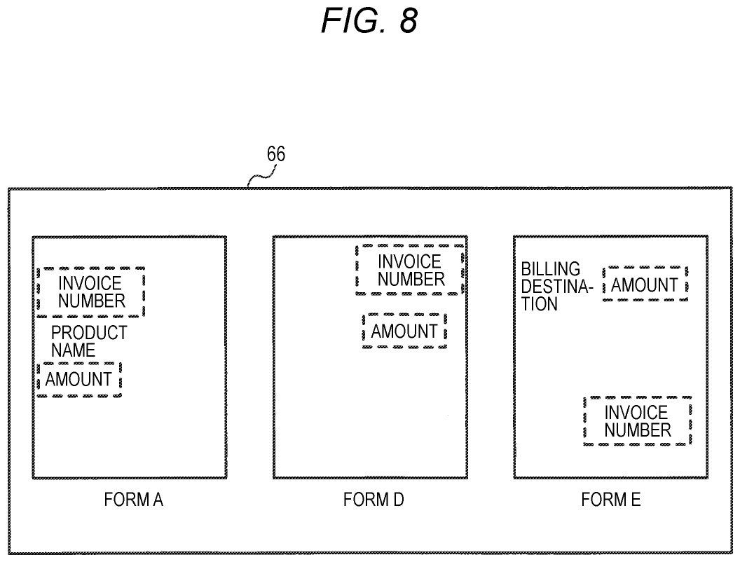

The processor 18 may distinguish between the common item in the plural documents and other items that are not common in the plural documents, and display the items on the display device. This point will be described in detail with reference to FIG. 8. FIG. 8 shows an example of a screen displayed on the display device.

As the example, forms A, D, E are documents to be associated, and document data of each of the forms A, D, E is received by the document reception unit 26. The processor 18 displays images of the forms A, D, E side by side on the screen 66.

In the forms A, D, E, the entry field of the item [invoice number] and the item [amount] are described, and these items are common in the forms A, D, E. In this case, the processor 18 emphasizes and displays the common items as compared with non-common items, as indicated by broken lines in FIG. 8. For example, the processor 18 encloses the common items with lines having a specific color and grays out the non-common items.

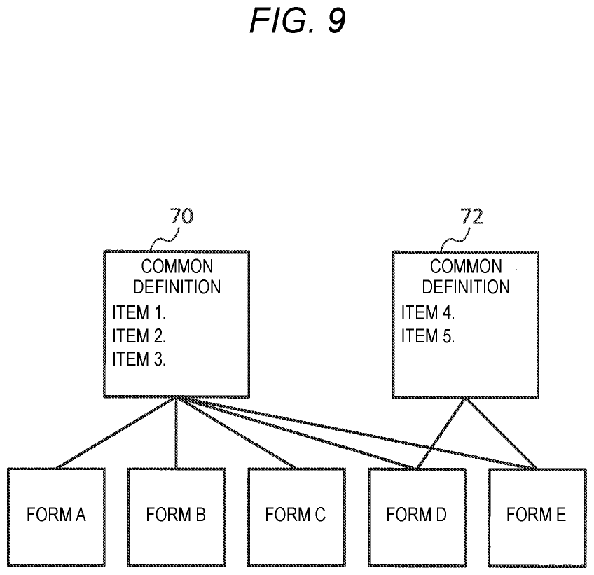

The plural pieces of common definition data may be associated with the frame data. This point will be described in detail with reference to FIG. 9. FIG. 9 shows an example of the forms and the common definition data. For example, common definition data 70 is associated with the frame data of each of the forms A, B, C, D and E. Common definition data 72 is associated with the frame data of each of the forms D, E. That is, common definition data 70, 72 is associated with the frame data of each of the forms D, E. The common definition data 70 is the definition data that defines content of items 1, 2, 3, and the common definition data 72 is the definition data that defines content of the items 4, 5. Since the content of the items 1, 2, 3 is common in the forms A, B, C, D, E, the common definition data 70 is associated with the frame data of each of the forms A, B, C, D, E. Since the content of the items 4, 5 is common in the forms D, E, the common definition data 72 is associated with the frame data of each of the forms D, E. In this way, the character recognition processing is performed on the forms D, E without separately creating the common definition data that defines all items 1, 2, 3, 4, 5.

### Second Exemplary Embodiment

A second exemplary embodiment will be described below. In the second exemplary embodiment, a document associated with common definition data and a screen for a user (for example, an operator) to associate individual definition data with the document are displayed on the same screen. The operator may set the individual definition data while referring to the document displayed on the same screen.

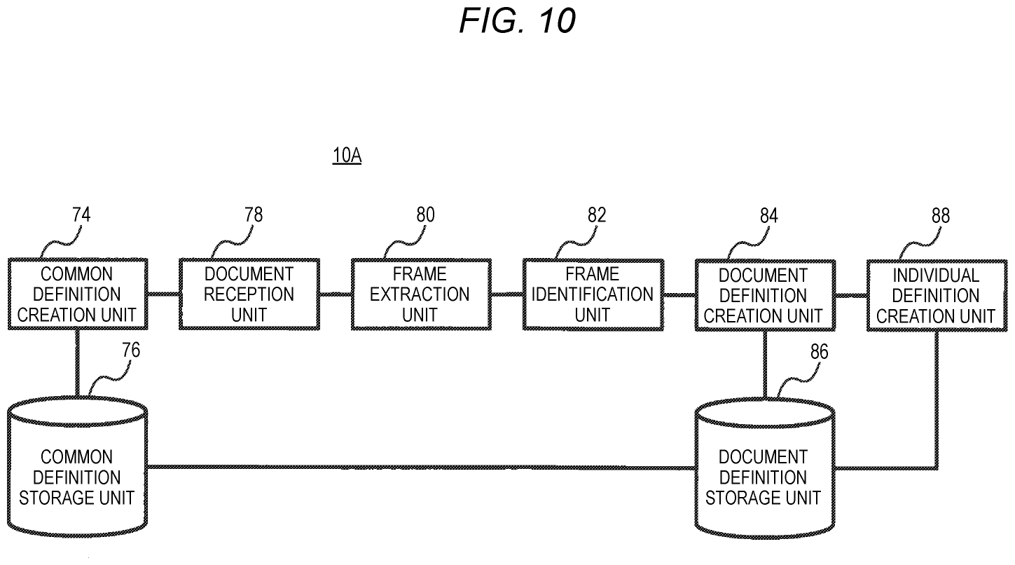

A functional configuration of an information processing device 10A according to the second exemplary embodiment will be described below with reference to FIG. 10. FIG. 10 shows an example of the functional configuration of the information processing device 10A. Since a hardware configuration of the information processing device 10A is the same as the hardware configuration of the information processing device 10 according to the first embodiment, a description thereof will be omitted.

A common definition creation unit 74 is configured to create the common definition data in the same manner as the common definition creation unit 20 according to the first exemplary embodiment.

A common definition storage unit 76 is configured to store the common definition data created by the common definition creation unit 74 in the same manner as the common definition storage unit 22 in the first exemplary embodiment.

A document reception unit 78 is configured to receive document data in the same manner as the document reception unit 26 according to the first exemplary embodiment.

A frame extraction unit 80 is configured to extract a frame from the document data received by the document reception unit 78 and to create frame data serving as data representing the frame in the same manner as the frame extraction unit 28 according to the first exemplary embodiment.

A frame identification unit 82 is configured to specify the frame corresponding to an item defined by the common definition data for each document to be associated with document definition data. For example, the frame identification unit 82 specifies the common definition data that defines an item corresponding to the item included in the document represented by the document data to be associated (for example, an item that matches the item included in the document) from plural different pieces of common definition data. The frame may be identified by using the common definition data without using the individual definition data by using a known technology described in JP-A-2004-258706 or the like. For example, the frame identification unit 82 extracts the frame from the document data to be associated, extracts a character string existing in vicinity of the frame, and specifies the common definition data that defines the item corresponding to the item included in the document represented by the document data by comparing a name of the item indicated by the extracted character string with a name of the item defined by the common definition data. For example, the frame identification unit 82 specifies the common definition data that defines the item having a name the same as the name of the item indicated by the extracted character string.

A document definition creation unit 84 is configured to associate the frame data of the document data to be associated and the common definition data specified by the frame identification unit 82. The frame data and the common definition data associated with each other are stored in a document definition storage unit 86.

The document definition storage unit 86 is configured to store the frame data and the common definition data associated by the document definition creation unit 84. As in the first exemplary embodiment, the common definition data itself may be stored in the common definition storage unit 76, and common definition identification information serving as information for referring to the common definition data may be stored in the document definition storage unit 86 in association with the frame data.

An individual definition creation unit 88 is configured to individually create the individual definition data for each document in the same manner as the individual definition creation unit 24 according to the first exemplary embodiment. In the second exemplary embodiment, the individual definition creation unit 88 creates the individual definition data for the frame data and the common definition data associated with each other. The created individual definition data is output to the document definition creation unit 84.

Upon receiving the individual definition data from the individual definition creation unit 88, the document definition creation unit 84 creates the document definition data by associating the individual definition data with the frame data and the common definition data associated with each other. The document definition data is stored in the document definition storage unit 86.

The common definition creation unit 74, the document reception unit 78, the frame extraction unit 80, the frame identification unit 82, the document definition creation unit 84 and the individual definition creation unit 88 are implemented by the processor 18. In this implementation, the memory 16 may be used. The common definition storage unit 76 and the document definition storage unit 86 are implemented by the memory 16.

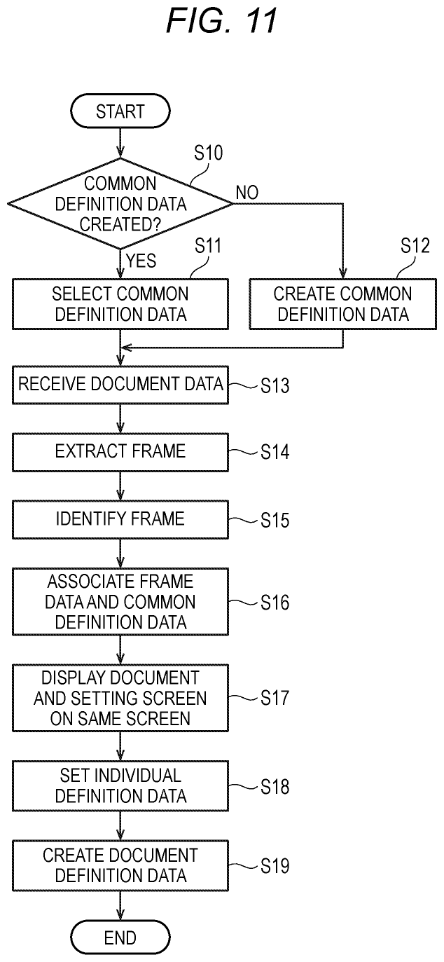

Processing by the information processing device 10A according to the second exemplary embodiment will be described below with reference to FIG. 11. FIG. 11 is a flowchart showing the processing.

First, it is determined whether the common definition data has been created (S10). This determination is performed by the processor 18.

When the common definition data has been created (S10, Yes), the common definition data is selected (S11). The created common definition data is stored in the common definition storage unit 76.

When the common definition data has not been created (S10, No), the common definition data is created (S12). The created common definition data is stored in the common definition storage unit 76.

Next, the document reception unit 78 receives the document data to be associated (S13).

Next, the frame extraction unit 80 extracts the frame from the document data to be associated, thereby creating the frame data serving as the data representing the frame (S14).

Next, the frame identification unit 82 identifies the frame, thereby specifying the common definition data associated with the frame data of the document data to be associated based on the common definition data and the frame data (S15).

Next, the document definition creation unit 84 associates the frame data extracted from the document data to be associated and the common definition data specified by the frame identification unit 82 (S16). The frame data and the common definition data associated with each other are stored in the document definition storage unit 86.

Next, the processor 18 displays, on the same screen, the document represented by the document data to be associated and the screen for the user (for example, the operator) to associate the individual definition data with the document (S17). More specifically, the processor 18 displays, on the same screen, the document represented by the document data to be associated and the screen for associating the individual definition data with the frame data of the document data. Hereinafter, the screen for associating the individual definition data with the frame data will be referred to as an “individual definition setting screen”. For example, in a display device of the UI 14, the document and the individual definition setting screen are displayed on the same screen.

Next, the operator sets the individual definition data for the document displayed on the same screen by using the UI 14 (S18).

The document definition creation unit 84 creates the document definition data by associating the individual definition data set in step S18 with the frame data of the document data representing the document and the common definition data (S19). The document definition data is stored in the document definition storage unit 86.

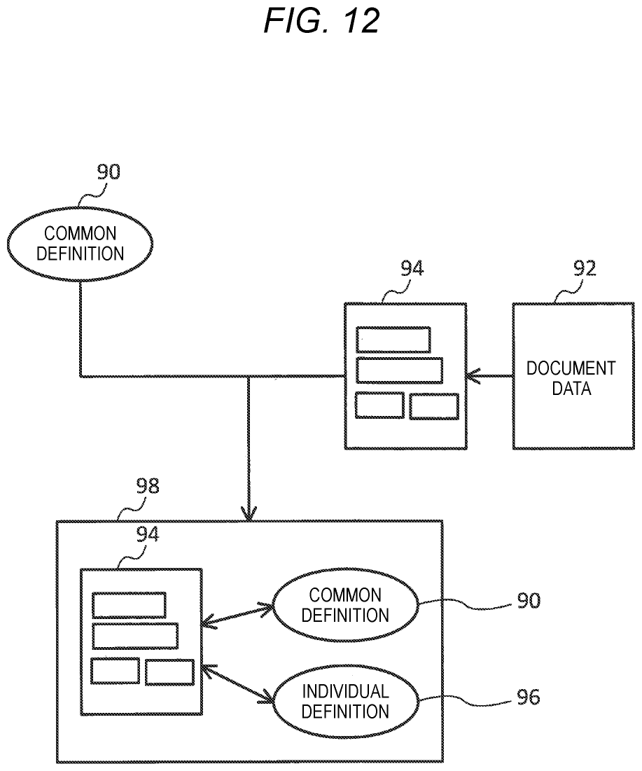

Here, a structure of the document definition data will be described with reference to FIG. 12. FIG. 12 shows an example of the structure thereof.

Here, common definition data 90 has been created. When document data 92 to be associated is received and a frame is extracted from the document data 92, frame data 94 serving as data representing the frame is created. By identifying the frame, the common definition data 90 associated with the frame data 94 is identified. Then, the frame data 94 and the common definition data 90 are associated. Individual definition data 96 is separately created, and the individual definition data 96 is associated with the frame data 94 and the common definition data 90. Thereby, document definition data 98 is created.

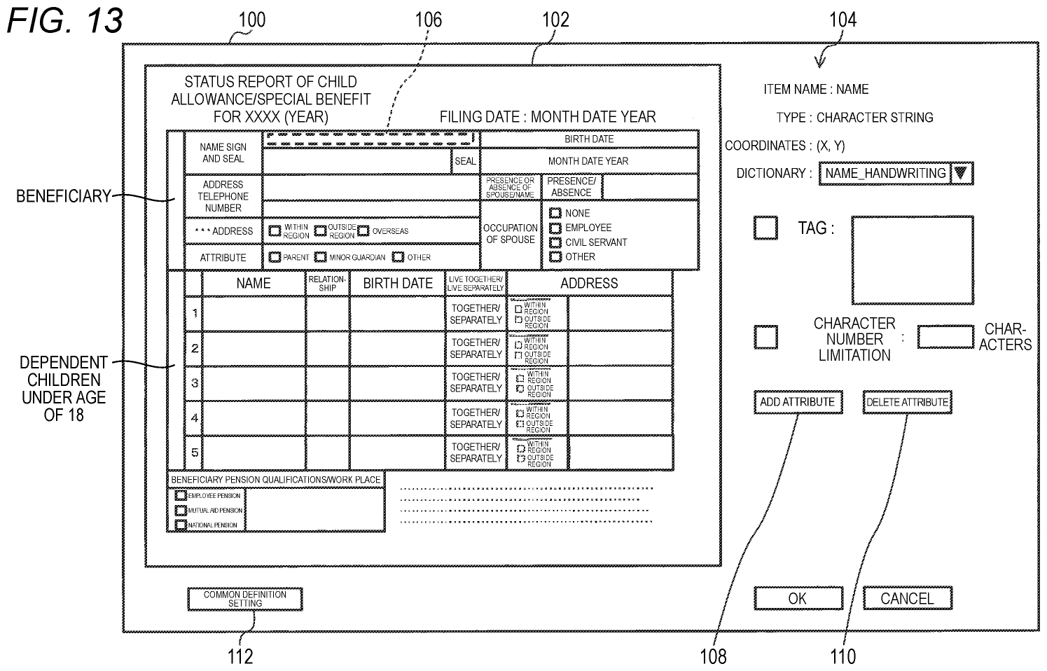

The individual definition setting screen will be described below with reference to FIG. 13. FIG. 13 shows the document to be associated and the individual definition setting screen.

A screen 100 is displayed on, for example, the display device of the UI 14 or a terminal device of the operator. For example, when the operator instructs to perform an operation of selecting the document data to be associated by specifying information (for example, a file name) for identifying the document data to be associated, and associating the individual definition data with the frame data of the document data, the processor 18 causes the display device to display the screen 100.

The screen 100 displays a document 102 to be associated selected by the operator and an individual definition setting screen 104 for the operator to associate the individual definition data with the frame data of the document 102. That is, the document 102 and the individual definition setting screen 104 are displayed side by side on the same screen 100.

The individual definition data may be set on the individual definition setting screen 104. For example, when a region on the displayed document 102 is designated by the operator, the processor 18 displays the individual definition setting screen 104 serving as a screen for setting the individual definition data for the designated region on the screen 100. For example, an entry field of an item “name” is designated by the operator as indicated by reference numeral 106. For example, a frame constituting the entry field is clicked by the operator. In this case, the processor 18 displays the individual definition setting screen 104 for setting the individual definition data for the entry field on the screen 100. The individual definition setting screen 104 displays a name of the designated item, a common definition already set for the item (that is, definition content of the common definition data associated with the frame data of the document 102), a setting field for setting the individual definition data, and the like. Here, as an example, since the item “name” is designated, an item name “name” is displayed, and a “type” as the common definition already set is displayed. Coordinates (that is, a layout of the item) of the entry field of the item “name”, a type of a dictionary (for example, a dictionary for handwriting or typing), a tag and a character number limitation may be set as the individual definition data. For example, a list of dictionary candidates (for example, a list showing dictionaries for handwriting and dictionaries for typing) is displayed by a pull-down method. The processor 18 may change and display the dictionary candidates according to the content defined by the common definition data. For example, when the item “name” is designated, the list of dictionary candidates corresponding to the item “name” is displayed. Although the definition content of the common definition data are also displayed on the individual definition setting screen 104, the definition content of the common definition data is prohibited from being changed in the individual definition setting screen 104, and the definition content thereof cannot be changed.

The processor 18 may distinguish and display the designated frame and the undesignated frame by thickening and displaying a line of the frame designated by the operator, or changing a color of the line of the frame.

As for a “ladder frame” constituted by plural frames connected to each other, when the plural frames are collectively selected by the operator, the processor 18 recognizes the “ladder frame” constituted by the plural frames as one frame. Then, the processor 18 displays the individual definition setting screen 104 for setting the individual definition data for the entry field constituted by the “ladder frame”.

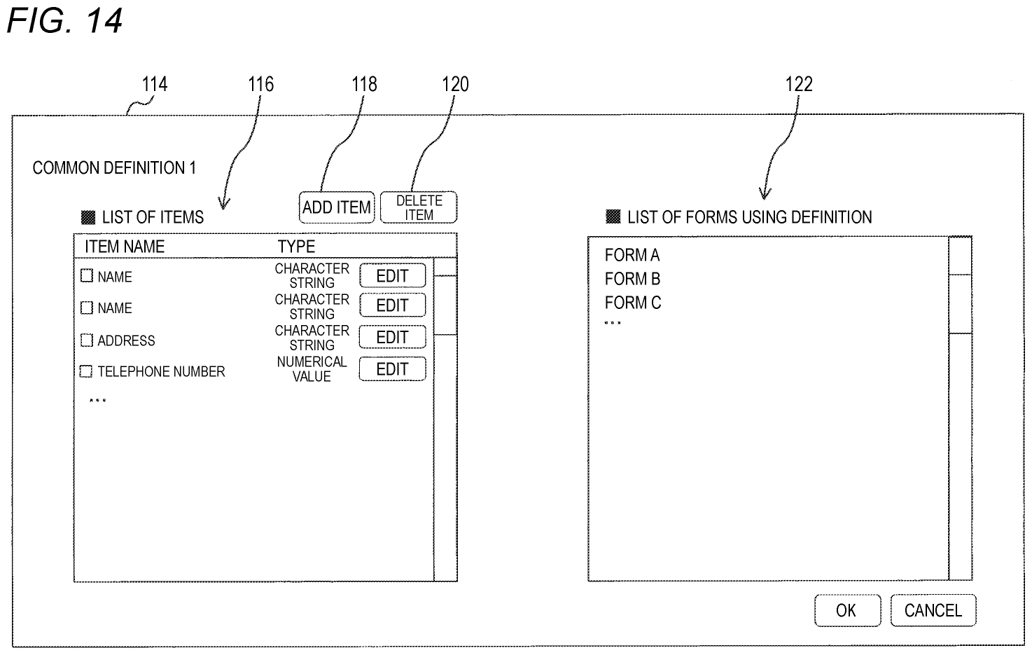

In addition, the individual definition setting screen 104 displays an add button 108 serving as a button for adding an attribute to be set to an item to be set (for example, the item “name”), and a delete button 110 serving as a button for deleting an attribute included in the item. In an example shown in FIG. 14, the attribute is the tag, the character number limitation or the like. When the operator presses the add button 108 on the screen 100, a setting field for defining a new attribute is displayed on the individual definition setting screen 104. When the operator presses the delete button 110 on the screen 100, a screen for deleting the attribute included in the item to be set is displayed on the individual definition setting screen 104. All attributes may be displayed on the individual definition setting screen 104.

When the operator presses an “OK” button displayed on the screen 100, the document definition creation unit 84 associates the individual definition data set on the individual definition setting screen 104 with the frame data of the document data to be associated and the common definition data, and stores the document definition data including them in the document definition storage unit 86. When the operator presses a “cancel” button, the individual definition data set on the individual definition setting screen 104 is not associated with the frame data and the common definition data, and processing of setting the individual definition data ends.

A common definition setting button 112 for setting common definition data is displayed on the screen 100. When the operator presses the common definition setting button 112 on the screen 100, a common definition setting screen (for example, another screen different from the screen 100) serving as a screen for setting the common definition data associated with the document data of the document 102 to be associated is displayed. FIG. 14 shows an example of the common definition setting screen.

A common definition setting screen 114 displays a name of the common definition data to be set (for example, “common definition 1”).

The common definition setting screen 114 displays a list 116 of items already defined by the common definition data. The operator may select an item to be set from the list 116 and edit definition content of the item.

The common definition setting screen 114 displays an add button 118 serving as a button for adding a defined item to the common definition data, and a delete button 120 serving as a button for deleting an item included in the common definition data. When the operator presses the add button 118 on the common definition setting screen 114, a setting field for defining a new item is displayed on the common definition setting screen 114. When the operator presses the delete button 120 on the common definition setting screen 114, a screen for deleting the item included in the common definition data is displayed on the common definition setting screen 114.

The common definition setting screen 114 displays a list 122 of the document data having the frame data associated with the common definition data to be set. For example, the frame data of each of the forms A, B, C is associated with the common definition data having the name “common definition 1”. That is, the common definition data having the name “common definition 1” is used as the definition data common in the forms A, B, C. When the common definition data having the name “common definition 1” is edited, the editing is reflected in the forms A, B, C. That is, since the common definition data having the name “common definition 1” is associated with the frame data of each of the forms A, B, C, when the common definition data is edited, the editing is reflected in each of the forms A, B, C.

When the operator presses an “OK” button displayed on the common definition setting screen 114, the document definition creation unit 84 reflects the content set on the common definition setting screen 114 on the common definition data to be set. When the operator presses a “cancel” button, the document definition creation unit 84 does not reflect content set on the common definition setting screen 114 on the common definition data to be set.

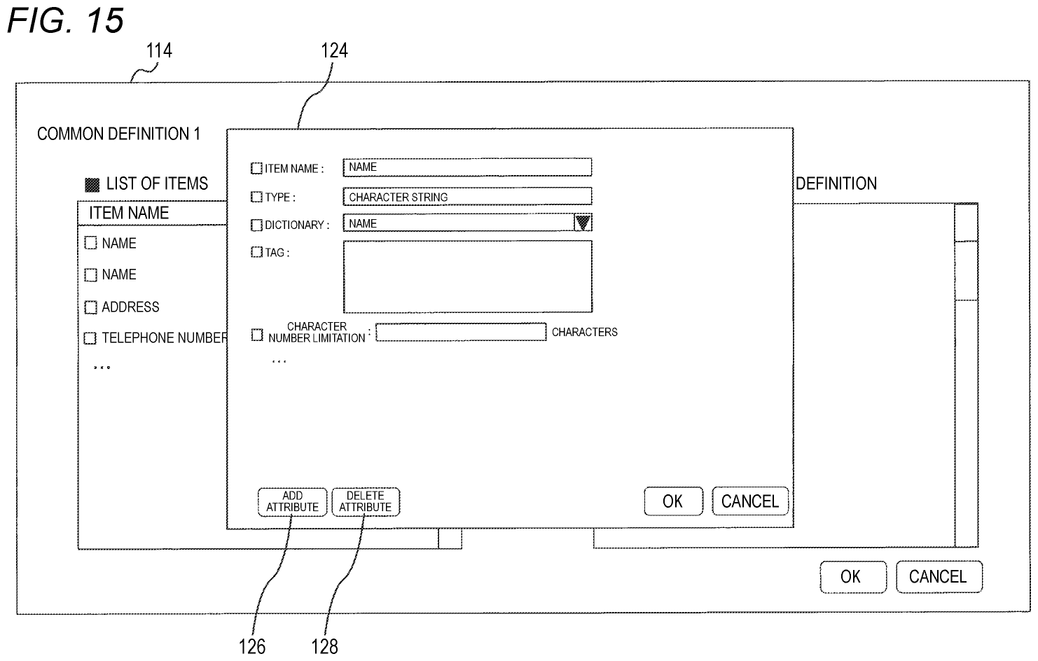

For example, when the operator selects an item “name” from the list 116 and instructs editing of the item, an editing screen serving as a screen for the editing is displayed. FIG. 15 shows an example of the editing screen.

An editing screen 124 displays setting items such as an item name, a type, a dictionary, a tag and a character number limitation. The operator may edit content set in the items on the editing screen 124. For example, the operator may change the type of the dictionary or the like.

The editing screen 124 displays an add button 126 serving as button for adding an attribute to be set to an item to be set (for example, the item “name”), and a delete button 128 serving as a button for deleting an attribute included in the item. When the operator presses the add button 126 on the editing screen 124, a setting field for defining a new attribute is displayed on the editing screen 124. When the operator presses the delete button 128 on the editing screen 124, a screen for deleting the attribute is displayed on the editing screen 124. All attributes may be displayed on the editing screen 124.

When the operator presses an “OK” button displayed on the editing screen 124, the document definition creation unit 84 reflects the content edited on the editing screen 124 on the common definition data. When the operator presses a “cancel” button displayed on the editing screen 124, the document definition creation unit 84 does not reflect the content edited on the editing screen 124 on the common definition data.

A modification of the second exemplary embodiment will be described below.

The processor 18 may cause the display device to display a screen for switching the definition data associated with the document to either the common definition data or the individual definition data. For example, the processor 18 causes the display device to display a screen for switching content defined in the individual definition data to content defined in the common definition data or a screen for switching the content defined in the common definition data to the content defined in the individual definition data. For example, the operator may change the content defined in the individual definition data to the content defined in the common definition data or change the content defined in the common definition data to the content defined in the individual definition data on those screens.

A specific example will be described. For example, in a case where content of an item [1. invoice number] (for example, alphanumeric, dictionary (alphanumeric), 10 digits) is defined as the common definition data, when the operator instructs to define the content as the individual definition data, the processor 18 defines the content as the individual definition data instead of the common definition data. For example, in a case where the content of the item [1. invoice number] is defined as the common definition data of the documents A, B, when the operator instructs to define the content as the individual definition data of each of the documents A, B, the processor 18 defines the content as the individual definition data of the document A and the individual definition data of the document B, and deletes the content from the common definition data of the documents A, B. For example, when the operator designates the documents A, B and instructs to switch the common definition data to the individual definition data, the content of the items defined as the common definition data of the documents A, B is displayed on the display device of the UI 14. When the operator designates content of an item to be defined as the individual definition data of each of the documents A, B from the displayed items, the processor 18 defines the content of the designated item in the individual definition data of each of the documents A, B, and deletes the content of the item from the common definition data of the documents A, B.

Contrary to the above example, when the operator instructs to define content common in the documents A, B and defined as the individual definition data of each of the documents A, B as the common definition data, the processor 18 defines the content as the common definition data of the documents A, B, and deletes the content from the individual definition data of each of the documents A, B. For example, when the operator designates the documents A, B and instructs to switch the individual definition data to the common definition data, the content of the items defined as the individual definition data of each of the documents A, B is displayed on the display device of the UI 14. When the operator designates the content of the item defined as the common definition data of the documents A, B from the displayed items, the processor 18 defines the designated content of the item as the common definition data of the documents A, B, and deletes the content of the item from the individual definition data of each of the documents A, B.

The processor 18 may propose the individual definition data common in the plural documents as the common definition data to the user (for example, the operator). For example, when there is an item having common content in plural pieces of document data, the processor 18 proposes the content of the item as the common definition data of the plural pieces of document data to the operator. Specifically, the processor 18 causes the display device of the UI 14 to display the content of the item. A specific example will be described. When there is an item having common content in the documents A, B, the processor 18 proposes the content of the item as the common definition data of the documents A, B to the operator. When content of a certain item is common in plural pieces of document data having a number equal to or larger than a predetermined threshold, the processor 18 may propose the content of the item as the common definition data of the plural pieces of document data to the operator. When the content of the item is separately defined as the individual definition data of each of the plural pieces of document data, the processor 18 may propose the content of the item as the common definition data of the plural pieces of document data to the operator.

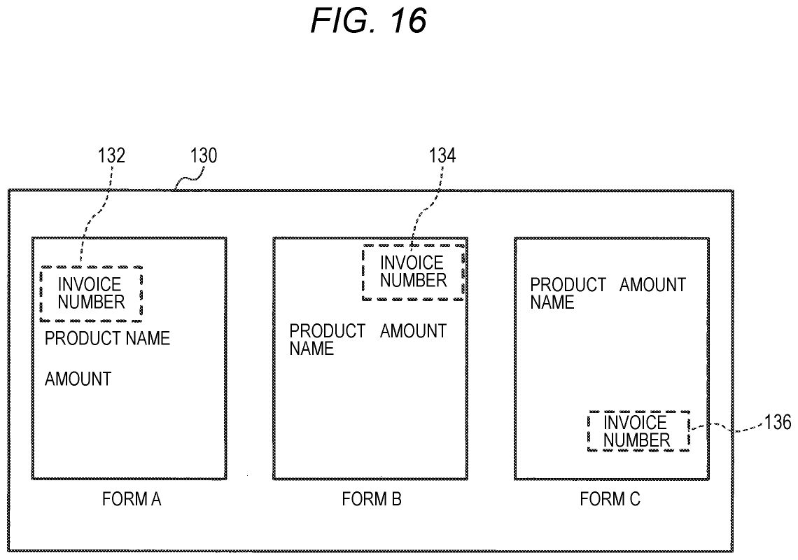

When plural documents are displayed on the same screen and a region on each displayed document is designated by the user (for example, the operator) for an item of the common definition data, the processor 18 may define the designated region as the region where content of the item is read in the individual definition data of each document. This point will be described in detail with reference to FIG. 16. FIG. 16 shows a screen.

For example, when the operator designates the forms A, B, C as documents to be associated and instructs to define the individual definition data, the processor 18 causes the display device to display a screen 130. The screen 130 displays the forms A, B, C. When the operator designates a frame constituting the entry field of the item “invoice number” of each of the forms A, B, C on the screen 130, the individual definition creation unit 88 defines the entry field constituted by the designated frame as a region where the content of the item “invoice number” is read in the individual definition data of each of the forms A, B, C.

This processing will be described in more detail. For example, when the operator instructs to set the layout of the item “invoice number”, the individual definition creation unit 88 receives the instruction. Next, when the operator specifies a frame 132 in the form A, a frame 134 in the form B, and a frame 136 in the form C, The individual definition creation unit 88 receives a position of the frame 132 in the form A as a position (that is, the layout) of the item “invoice number” for the form A, receives a position of the frame 134 in the form B as a position of the item “invoice number” for the form B, and receives a position of frame 136 in the form C as a position of the item “invoice number” for the form C. That is, the individual definition creation unit 88 defines the position (that is, the layout) of the frame 132 in the form A as a position of a region where the content of the item “invoice number” is read from the form A in the individual definition data of the form A. Similarly, the individual definition creation unit 88 defines the position of the frame 134 in the form B as a position of a region where the content of the item “invoice number” is read from the form B in the individual definition data of the form B. Similarly, the individual definition creation unit 88 defines the position of the frame 136 in the form C as a position of a region where the content of the item “invoice number” is read from the form C in the individual definition data of the form C.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a processor configured to
associate, for a document of a plurality of documents, common definition data that defines content of a common item commonly used in the plurality of documents including the document, among at least one item read from the document, and individual definition data that defines content of an item individually for each of the plurality of documents, among the at least one item read from the document, with document data representing the document.

2. The information processing device according to claim 1, wherein
the individual definition data is data defining a layout of the item in the document.

3. The information processing device according to claim 2, wherein
a plurality of different pieces of common definition data and a plurality of different pieces of individual definition data are defined, and
the processor is further configured to
associate common definition data that defines content of item corresponding to an item included in a document to be associated among the plurality of different pieces of common definition data and individual definition data that defines a layout corresponding to a layout of the document to be associated among the plurality of different pieces of individual definition data, with the document data representing the document to be associated.

4. The information processing device according to claim 1, wherein
the processor is further configured to
display the content of the common item read from the plurality of documents.

5. The information processing device according to claim 2, wherein
the processor is further configured to
display the content of the common item read from the plurality of documents.

6. The information processing device according to claim 3, wherein
the processor is further configured to
display the content of the common item read from the plurality of documents.

7. The information processing device according to claim 4, wherein
the processor is further configured to
display the plurality of documents on a display device, and
display the content of the common item distinguishably from content of another item on the display device.

8. The information processing device according to claim 5, wherein
the processor is further configured to
display the plurality of documents on a display device, and
display the content of the common item distinguishably from content of another item on the display device.

9. The information processing device according to claim 6, wherein
the processor is further configured to
display the plurality of documents on a display device, and
display the content of the common item distinguishably from content of another item on the display device.

10. The information processing device according to claim 1, wherein
the processor is further configured to,
in a case where an edit is made in the common definition data, reflect the edit on each document associated with the common definition data.

11. An information processing device comprising:
a processor configured to
display a document with which common definition data that defines content of a common item in a plurality of documents among items read from the document is associated, and a screen in which a user associates individual definition data that defines content of an item individually for each document among the items to be read in the document with the document, on a same display screen.

12. The information processing device according to claim 11, wherein
the processor is further configured to
display, in a case where a region on the displayed document is designated by the user, a screen for setting the individual definition data corresponding to the designated region, on the same display screen.

13. The information processing device according to claim 11, wherein
the individual definition data is data defining a layout of the item in the document, and
the processor is further configured to
display the plurality of documents on the same display screen, and
define, in a case where a region is designated by the user on each of the plurality of displayed documents for an item of the common definition data, the designated region as a region where the content of the item is to be read, in the individual definition data.

14. The information processing device according to claim 11, wherein
the processor is further configured to
display a screen for switching definition data associated with the document to either the common definition data or the individual definition data.

15. The information processing device according to claim 11, wherein
the processor is further configured to
propose individual definition data commonly used in the plurality of documents as the common definition data to the user.

16. A non-transitory computer readable medium storing a program causing a computer to execute a process comprising:
associating, for a document of a plurality of documents, common definition data that defines content of a common item commonly used in the plurality of documents including the document, among at least one item read from the document, and individual definition data that defines content of an item individually for each of the plurality of documents, among the at least one item read from the document, with document data representing the document.
